(19) United States
(12) Patent Application Publication
(10) Pub. No.: US 2002/0107756 A1
(43) Pub. Date: Aug. 8, 2002

(54) Method for creating and operating a personalized virtual internet store including "disconnected" purchasing capability

(76) Inventors: James P. Hammons, Boise, ID (US); Laura L. Silsby, Boise, ID (US)

Correspondence Address: DYKAS, SHAVER & NIPPER, LLP, P O BOX 877, BOISE, ID, 83701-0877, US

(21) Appl. No.: 10/025,957

(22) Filed: Dec. 18, 2001

Related U.S. Application Data
(60) Provisional application No. 60/256,808, filed on Dec. 18, 2000.

(51) Int. Cl. G06F 17/60

(52) U.S. Cl. 705/26

(57) ABSTRACT

A computer network system gathers, organizes and stores information about products, product offers, and customers, and the parties for whom the customers wish to purchase gifts. This customer information is gathered, organized and stored in the system information computer. Based on information about the customer's needs, as collected, the service compares the information regarding the customer's needs and the products and offers in its database. The service then delivers tailored product offers and/or informative displays to the customer based upon these needs. These product offer and/or informative displays are delivered from an information system computer over a communication network and stored on the customer's display device. The customer can then create or accept transactions. These product offers and transactions and/or informative displays can be processed immediately and/or reserved for later processing. They can also be utilized and transactions initiated even when the display device is not attached to the network.

### CROSS-REFERENCE TO RELATED INVENTION

This patent application claims priority from and incorporates herein by reference U.S. patent application Ser. No. 09/478,649 filed on Jan. 6, 2000 and provisional patent application serial No. 60/256,808 filed Dec. 18, 2000 entitled “Patent Application for Personalized “Virtual Internet Store” Based on Profile Information and Gift Planning Information Provided by Customer.”

### BACKGROUND OF THE INVENTION

1. Field of the Invention

The present invention generally relates to methods of business retail sales and more specifically to a method of conducting business on a communications system or information network such as the Internet or a wireless communications network.

2. Background of the Invention

Recently, a wide variety of business models have been utilized in conducting business on the global communication network known as the Internet. The Internet allows parties to buy, sell and shop in thousands of different locations and stores. Thus, the Internet has opened up a variety of contacts between persons and businesses in ways that were not possible before. Businesses and, particularly, advertising companies have attempted to utilize the Internet to sell their products to broader audiences.

One problem that has arisen in conducting commerce over the Internet is that many consumers find that their lives are so busy that it is difficult to make the time to find the right item to purchase or to select just the right gift for a gift occasion. They often find that they have to set aside or schedule time to scour the Internet looking for the right gift idea for a particular person or gift occasion. Conversely, they also find themselves with “idle time” when they have the time to spend on this type of activity, but no ability to access the Internet or other communications network to complete the purchase. For example, during a commercial airplane flight or subway ride, many have idle time where they could use a portable personal computer or personal digital assistant or other device to complete some of their shopping, but do not have a connection to any kind of network to initiate a purchase.

Another problem is the difficulty sellers have in reaching the correct buyers for the products they sell, and for buyers in finding the right products that they wish to acquire. Few, if any, of the commerce solutions today can definitely predict which products are of interest to which users of the Internet system. Clear customer profiling and the ability to match products to the customer's profile has been attempted, but has not been adequately implemented because of the extremely limited time that a customer spends at any single Internet site.

A third problem that has developed in consumer shopping over the Internet is that a party will normally have to go to multiple websites looking for the things that they may be interested in purchasing, then making multiple purchasing stops, entering personal information multiple times to complete their purchases. This can result in significant amounts of time looking for the right products to purchase and in completing those purchases. At certain times of the year, during holiday shopping season for example, when a party wants to purchase multiple items or gifts for other people on their shopping list this problem is compounded.

A fourth problem in buying and selling goods over the Internet is in matching the best buyer with the best seller for a particular transaction. Buyers often exist who would pay a higher market price for a particular product, but may not be aware that the product is available for sale. Sometimes multiple sellers exist for a particular product, but a buyer may not be aware of all of the sellers available. This lack of product information availability results in higher prices for the products purchased. It is often the case that the best buyer and best seller for a particular product do not meet or make connections to buy and sell their goods. This is a result of there being so many places for a seller to sell their goods and so many places for a buyer to buy goods, that often times the best buyer and the best seller are never put into contact with one another. Thus, a buyer could pay a higher price than necessary, a seller could sell a product for less than the market will bear, or potential sales and purchases may even never occur.

What is needed is a system wherein businesses can efficiently introduce their products to potential purchasers wherever they may be and whenever they have time available. What is also needed is a system wherein parties can save time and money in shopping by presenting a profile to a business which will then find and channel product information and offers consistent with that submitted profile. What is also needed is a business model which allows a customer to create a “store” of selected information and product offers for both the customer and persons to whom the customer would like to give gifts, while also receiving new offers and information regarding new or different products. What is also lacking is a way for individual sellers to transmit their product offers to as many interested parties as possible, resulting in more efficient buying and selling.

### SUMMARY OF THE INVENTION

Accordingly, it is a general object of this invention to provide a system and a business model wherein businesses can efficiently introduce their products to potential purchasers wherever those potential purchasers may be and whenever those potential purchasers have available time.

It is also an object of the present invention to provide a system wherein customers can save time and money in shopping by presenting a profile to a business which will then find and channel product information and offers consistent with that submitted profile to the customer.

It is another object of the present invention to provide a business model which allows a customer to create a “store” of selected information and product offers for both the customer and persons to whom the customer would like to give gifts, available for later selection and purchase. This “store” would also have the ability to present new offers and information regarding new or different products to the customer who could then choose whether or not to include such items in their “store” of items for future purchases.

It is also an object of the present invention to provide a way for individual sellers to transmit their product offers to as many interested parties as possible, resulting in more efficient buying and selling.

Additional object, advantages, and novel features, of the invention shall be set forth in part in the description that follows and in part will become apparent to those skilled in the art upon examination of the following or may be learned by practice of the invention. The objects and advantages may be realized and attained by means of the instrumentalities and in combinations particularly pointed out in the appended claims.

The method or system of the present invention operates on a network in which, typically, a number of computers and/or devices have access. An information system computer (Server) is also linked to the network, and provides information storage, comparison capabilities, and integration functions to the method and system of the invention. The information system computer is the system management entity, and can actually be one or a number of computers, which perform the system management functions.

The system gathers and stores information about products, and product offers. This information is then organized and stored within the information system computer. The system then gathers and compiles information regarding the customer, their preferences and the parties for whom the customer wishes to purchase gifts. This information is gathered, organized and stored in the system information computer.

Based on information about the customer's needs, as collected, and the related information the service has developed regarding the products and offers available, the service compares the information regarding the customer's needs and the products and offers in its database. The service then delivers tailored product offers and/or informative displays to the customer based on these needs.

These product offer and/or informative displays are delivered from an information system computer or Server over a communication network and stored on the customer's display device. These product offer and/or informative displays can be displayed immediately and/or reserved for later display when the display device is no longer attached to the network. Whenever the display device is reconnected to the network, product offer and/or informative displays can be refreshed from the Server.

Once the product offers and /or informative displays are displayed on the display device, the customer can initiate a purchase or other transaction/process. Other transactions include, for example, “tagging” or selecting items which the customer has an interest. These selected items can be organized in to a personal “store” of items which the customer has selected and set aside for possible future purchases. Thus instead of having to go to various locations to find items that the customer has already found, the customer can simply go to their personal “store” and purchase these items.

These processes can take place even when the device is not connected to the network. Based on preferences and network availability, the device can then automatically connect to the network and deliver the purchase, bid, offer for sale or other transaction to the Server, optionally without additional interaction from the user. Additionally, if a network connection is not immediately available, the device may store the transaction for transmission to the Server when a connection becomes available.

Another feature of the present invention is that the service can organize the customer's gift-giving recipients, their interests and attributes and the gift giving events for each recipient. The customer inputs information regarding the parties for whom the customer wishes to purchase gifts. The Server organizes and stores this information then matches this information with the information stored in the Server. The Server then sends the best matches for each particular gift event at the appropriate time to the display device where the results can be readily displayed or if so desired, the display can be held until later.

The results from this display can then be ordered directly from the personal shopper feature on the customer's device, whether the device is attached to the network or not. Displays tagged by the customer and added to the customer's “store” are also added to the shopping selection and are organized by occasion, recipient and month. Together these products create a virtual “store” that is completely customized for each recipient and/or gift-giving occasion that the customer has identified. Each store is completely unique for each customer and will be created individually, with tailored product offers and/or informative displays selected from all product offers and/or informative displays available. These displays are based on the customers profile and the information given to system regarding the recipients and gift events and presented to the customer upon their request to their device. This “store” can also be accessed from a designated website or from the customer's display device, and may optionally be accessed whether or not the display device is connected to the network.

When product offer and/or informative displays are displayed to the customer on the display device, the customer can select the product offer and with a “right click” or other selection mechanism, initiate specific processes. These processes can impact the product offer itself and/or the information displayed in the “virtual store,” the gift planner, and/or the customer's profile information.

Individual customers can provide information in their profiles that indicates an interest in particular products or services that may be offered for sale or auction by other individual customers or organizations. When those products or services are then offered for sale or auction, the individual customer can choose to have the product offer or auction participation opportunity automatically delivered to their device for display. The customer can then choose to purchase or participate in the auction directly from their device at that time.

Individual customers can provide products or services for sale or for auction to be delivered directly to the devices of other individual customers or organizations who have expressed an interest in those products or services. The customer may provide descriptions, pricing, photographs and payment information regarding their product or service for display to those other individual customers. Additionally, the selling customer may provide additional information, which will help identify which customers, may be interested in their product or service.

If information has been given which help parties to identify what product or services they would be interested in the information system computer would then integrate the system user profile information with the product information provided by information providers and sellers. Product information that matches the system user profile information would be selected, and provided to the system user for viewing on the user's device. The selected product information is sent to the system user's device when the system user connects to the network. For example a customer with a particular interest in collecting baseball memorabilia would have this included as a part of their profile. When baseball memorabilia was available from an outside party such as an individual party on an electronic auction site, this could then appear as one of the choices available to the customer in selecting an item to purchase. The customer could then enter a bid for that product directly from their device, or optionally from within their personal “store,” following a similar process as they would if the customer were purchasing an item on-line from a retail information provider.

The information provider or providers may optionally pay a presentation fee to the service or management company, for each unit of information, which is presented to the system user. The system user also has the ability of interacting with the product information or advertising. This would typically be by ordering a product, or investigating a product or other information more fully. If a system user buys a product from an information provider, then the information provider pays a further fee, or sales commission.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 is a diagrammatic representation of the method and system of network participation of the invention.

FIG. 2 is a block diagram showing the transfer of information and interactions of the system and method.

FIG. 3 is an example of a screen display of the system.

### DESCRIPTION OF THE PREFERRED EMBODIMENT

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

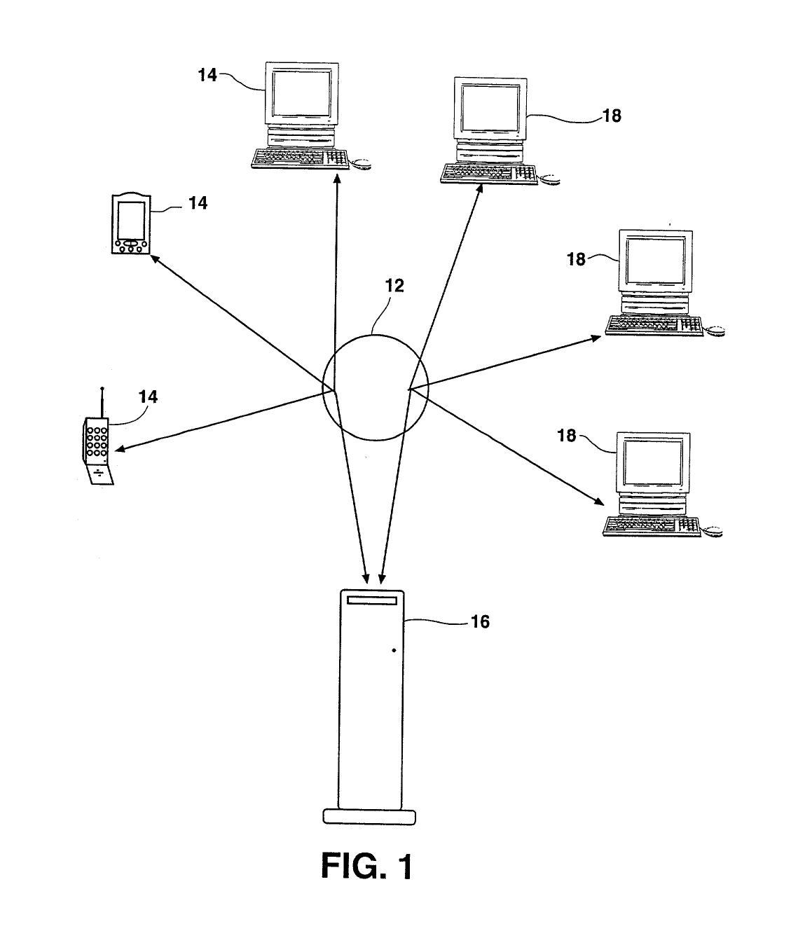

The method or system of the invention operates on a network connecting a variety of types and forms of computers and other display devices such as hand held personal organizers, lap top computers, and cell-phones. and the like. FIG. 1 shows an example of an overall environment in which the present invention may be used. This environment includes a network 12, an example of which could be the Internet or some future communications network. A number of display devices such as personal computers or information appliances 14, operated by system users, are attached to the network 12. These display devices 14 are connected through the network 12 to one or more information system computer 16. Also connected to the information system computer 16 are a number of other computers, representing information provider computers 18. Information providers 18 are also connected to the information system computer 16 through the network 12. The information providers 18, also called Servers, are linked to the network 12, and provide information storage, comparison capabilities, and integration functions to the method and system of the invention. The information system computer 16 is the system management entity, and can actually be one or a number of computers, that perform system management functions. Each of the parties involved in the system have the ability to receive and send information from the display device 14, to the central computer

The system or method of network participation operates with the number of steps in a cycle, although each of the steps of the cycle may be occurring simultaneously. The system can best be explained by illustrating one particular cycle, with all of its steps, for one particular system user 14.

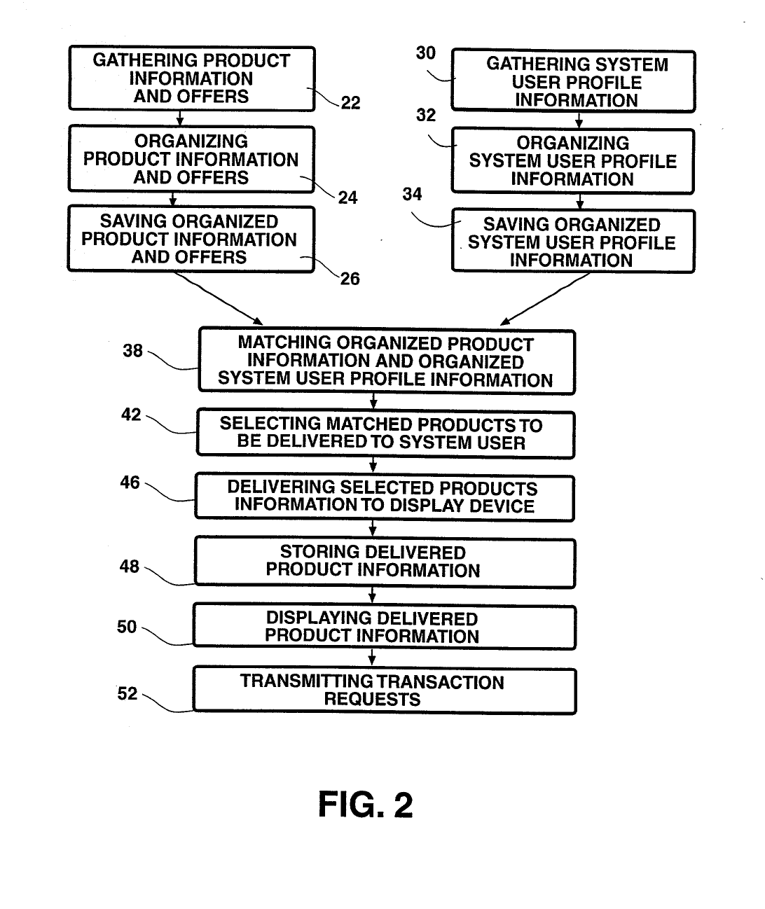

FIG. 2 shows one possible cycle of the method or system for one system user 14. This cycle begins with a product information gathering step 22. An information provider 18 provides information about products and services to the information system computer 16, that they are interested in displaying to system users 14. In one configuration of the system, the information providers would be merchants, and the information they provide would be concerning various products and services, which they sell. For instance, a merchant could be a seller of electronic products, and the information she provides to the information system computer would include photographs of her products, description of her products, prices of each product, and also profile information which can be used to associate a product with a system user. The information system computer 16 system gathers and stores this information about products, and product offers. The retail companies may pay a fee to the system manager to allow their materials to be included in the service. This database can be updated as is needed to ensure that the best selection of goods for purchase is available.

The system may also have agreements with individual sellers, on-line auction companies, and other entities who and may enter their items into the database of personal services. All of this product information and services are then ranked and organized according to characterization and selection criteria. This organized product information is then saved within a database within the information system computer 16.

For instance, a particular information provider 18 may be a merchant who is interested in selling a particular piece of software to a system user. The information provider may indicate that the type of system user who is likely to be interested in this software is a system user who has children between the ages of 6 and 10 years, and who has an income of greater than $50,000 per year. The merchant may further indicate that this information is best suited for a consumer who lives in a western state, and who has at least a college level of education. In step 24, these factors are given a value and are organized. In step 26 this organized product information is stored within a database by the computer information system computer 16. These three steps, 22, 24, and 26 are on going as merchants increase the numbers and variety of products they desire listed for sale.

A parallel set of steps 30, 32, and 34 may occur subsequent, prior or simultaneously with steps 22, 24, and 26. In step 30, information is gathered from the system users 14, also called the customers, regarding both themselves and the parties for whom they wish to purchase gifts. This information can be obtained directly from the customer by having the customer complete a customer profile when first accessing or logging into the service, or the information can be collected from the customer's interaction with provided software, or by other information gathering techniques. This system user profile information that is gathered may include information such as age, occupation, personality, children, sex, income level, and residence hobbies, and the like. This system user profile information is gathered, organized and stored in a database within the system information computer 16. The user profile information can also include information of a much more detailed nature and more comprehensive in scope. This could include information about a spouse's shopping habits, wedding anniversaries, the birthdays of relatives, the ages of one's children, sex and birthdays, family's hobbies, political inclinations, and interest in particular advocacy groups or political parties. In addition to the user profile information, which the system user 14 sends to the information system computer 16, a customer also has the ability to provide an information profile about a person for whom the customer will purchase a gift, and designate when and for what event that gift is to purchased. Occasions such as birthdays, Christmas, Hanukkah, Valentines Day, anniversaries and the like are also organized and stored along with the other personal profile information. All of this system use profile information is organized, and characterized in step 32 and stored in the information computer 16 in step 34.

When the system user 14 enters into the computer network 12, the product information stream and the profile stream of information are merged, and matched in step 38. At this matching step 38, particular product offers and/or information from the information provider 18 are selected by an algorithmic analysis for display to a particular system user 14.

The service attaches values to each product characteristic, each profile trait and each event and assigns values to all of these. These values are then compared and analyzed through at least one algorithm to obtain a list of matching results. The items, which are shown to have the greatest amount of matching material, through this algorithm, are listed first while those that have lesser matching characteristics are listed later down the list.

From these results, the system selects those gifts that are most closely matching while also ensuring that a variety of products are shown 42. For example, if the service listed 50 DVD players and the results of the analysis showed that a DVD player was the most appropriate gift, the Server would not show 50 DVD players, rather it would show one DVD player and other gifts that although may have a lower score in the algorithm have provide for a better variety. The service then delivers tailored product offers and/or informative displays to the customer based upon these needs.

These product offer and/or informative displays are delivered 46 from an information system computer or Server over a communication network and stored 48 on the customer's display device, where they can be displayed 50. These product offer and/or informative displays can be displayed immediately and/or reserved for later display when the display device is no longer attached to the network. Whenever the display device is reconnected to the network, product offer and/or informative displays can be refreshed from the Server.

Once the product offers and/or informative displays are displayed on the display device, the customer can initiate a purchase or other transaction/process 52. Transactions and transaction requests are meant to include all transactions including but not limited to: making offers to purchase from a seller, placing bids in an electronic auction, placing items for sale in an auction and making offers to sell to a third party.

At step 46, the selected information for a particular system user 14 is sent to the display device pertaining to system user 14. The selected information can be displayed on the system user's 14 display device, in a manner so that they can continue to operate their computer for its normal tasks, or depending upon the personal preferences of the system user this display could be postponed for another time. Typically the information would be displayed along one or both sides of the computer, or along the top and/or bottom of the computer.

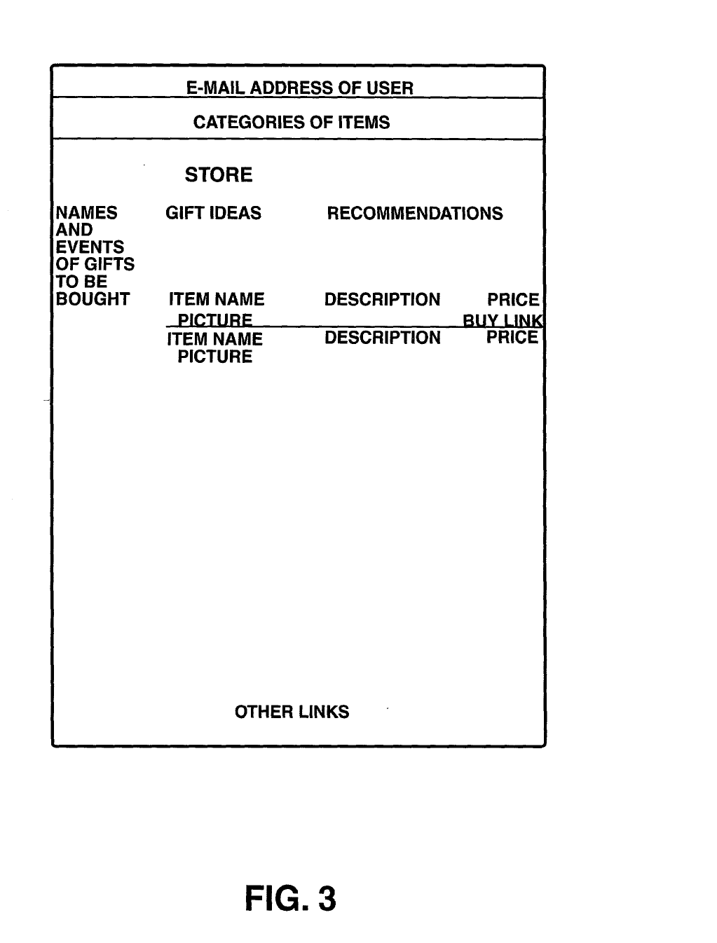

FIG. 3 shows an example screen of how targeted information 24 could be displayed on a system user's 14, computer screen. The information displayed in FIG. 3 is meant to be an example of one type of information which may be displayed on one type of display device to a user, and is not meant to limit the scope of the invention or the type of information

In FIG. 2 the processes of display 50, and transaction selection 52 can take place even when the device is not connected to the network. If the device is not connected the transactions will just be stored. Later, based upon preferences and network availability, the system user's device 14 can then automatically connect to the network 12 and deliver the purchase, bid, offer for sale or other transaction to the Server, optionally without additional interaction from the user. Additionally, if a network connection is not immediately available, the device may store the transaction for transmission to the Server 16 when a connection becomes available.

Another feature of the present invention is that the service can organize the customer's gift-giving recipients, their interests and attributes and the gift giving events for each recipient. The customer inputs information regarding the parties for whom the customer wishes to purchase gifts. The system Server 16 organizes and stores this information then matches this information with the information stored in the Server 16. The Server 16 then sends the best matches to the display device where the results can be readily displayed or if so desired, the display can be held until later.

The results from this display can then be ordered directly from the personal shopper feature on the customer's device, whether the device is attached to the network or not. Displays tagged by the customer, are also added to the shopping selection and are organized by occasion, recipient and month. Together these products create a virtual “store” that is completely customized for each recipient and/or gift-giving occasion that the customer has identified. Each store is completely unique for each customer and will be created individually, with tailored product offers and/or informative displays selected from all product offers and/or informative displays available. These displays are based on the customers profile and the information given to system regarding the recipients and gift events and presented to the customer upon their request to their device. This feature may be called “My Store” can also be accessed from a designated website or optionally from the customer's display device, regardless of whether or not they are connected to the network.

When product offer and/or informative displays are displayed to the customer on the display device, the customer can select the product offer and with a “right click” or other selection mechanism, and initiate specific processes. These processes can impact the product offer itself and/or the information displayed in the “virtual store,” the gift planner, and/or the customer's profile information.

Specific processes that can initiated by this process include but are not limited to: selecting the “Back” function of the device to return the display to the product offer or informative display previously displayed; selecting “Add to My Store” which allows the customer to select a recipient and/or gift event to which the selected product offer and/or informative display will be linked in the customer's “virtual store” called in this embodiment “My Store;” selecting “Not interested” this allows the customer to identify product offers and/or informative displays in which they are not interested and optionally provide reasons why not; selecting “Show me more like this” this function allows the customer to identify product offers and/or informative displays which have a similarity to others they would like to receive and optionally provide reasons why; selecting “Future purchase” allows the customer to identify product offers and/or informative displays that they would like to purchase at a specific point in the future. The customer can optionally confirm the purchase to take place automatically at that point in the future.

Individual customers can provide information in their profiles that indicates an interest in particular products or services that may be offered for sale or auction by other individual customers or organizations. When those products or services are then offered for sale or auction, the individual customer can choose to have the product or service offer or information automatically delivered to their device for display. The customer can then choose to purchase or participate in the auction directly from their device at that time.

Individual customers can provide products or services for sale or for auction to be delivered directly to the devices of other individual customers or organizations who have expressed an interest in those products or services. The customer may provide descriptions, pricing, photographs and payment information regarding their product or service for display to those other individual customers. Additionally, the customer may provide additional information, which will help identify which customers, may be interested in their product or service.

If information has been given which help parties to identify what product or services they would be interested in the information system computer would then integrate the system user profile information with the product information provided by information providers. Product information, which matches the system user profile information, would be selected, and provided to the system user for viewing on their computer screen. The selected product information is sent to the system user's display device when the system user connects to the network. For example, a customer with a particular interest in collecting baseball memorabilia would have this included as a part of her profile. When baseball memorabilia was available from an outside party such as an individual party or an electronic auction site, this would appear as one of the choices available to the customer in selecting a gift. The customer could then enter a bid from that site within the store, similarly to as if the customer were purchasing an item on-line from a retail information provider.

Individual customers can provide products or services for sale or for auction to be delivered directly to the devices of other individual customers or organizations who have expressed an interest in those products or services. The customer may provide descriptions, pricing, photographs and payment information regarding their product or service for display to those other individual customers. Additionally, the customer may provide additional information, which will help identify which customers, may be interested in their product or service

While there is shown and described the present preferred embodiment of the invention, it is to be distinctly understood that this invention is not limited thereto but may be variously embodied to practice within the scope of the following claims.

From the foregoing description, it will be apparent that various changes may be made without departing from the spirit and scope of the invention as defined by the following claims.

We claim:

1. In an arrangement comprising at least one network linking at least one information system computer, to at least one display device, said display device associated with at least one system user, a method for providing specific product information and offers for sale to said system user, said method comprising the steps of:
gathering product information regarding a variety of product offers and information;
organizing said product offers and information based upon predetermined criteria;
saving said organized product offers and information in a database;
gathering system user profile information from said system user;
organizing said system user profile information, according to predetermined criteria;
saving said organized system user profile information;
matching said organized product offers and information to said organized system user profile information according to a designated criteria;
selecting matched product offers and information to be transmitted to said display device based upon desired criteria;
delivering said matched product offers and information to said system user through said display devices;
storing said matched product offers and information on said display device;
displaying said delivered matched product offers and information; and
transmitting transaction requests from said system user.

2. The method of claim 1, wherein said transaction requests are able to be made when said display device is not connected to said network, said transaction requests being stored within said display device until said display device is connected to said network, whereupon said transaction requests are transmitted to said information system computer.

3. The method of claim 2, wherein said step of transmitting transaction requests includes making offers to purchase from a seller, placing bids in an electronic auction, placing items for sale in an auction and making offers to sell to a third party.

4. The method of claim 2, wherein new matched product offers are delivered to said display devices whenever said display device is connected to said network.

5. The method of claim 2, wherein said product offers and information are displayed immediately.

6. The method of claim 2, wherein said product offers and information are reserved for later display when said display device is no longer attached to said network.

7. The method of claim 6, wherein said display device is able to store said transaction and automatically connect to said network at a later time based upon pre-selected preferences and system availability.

8. The method of claim 2, further comprising the steps of:
gathering gift-giving information from said system user about said system user's gift giving recipients;
storing said gift-giving information;
organizing said gift-giving information according to designated criteria;
matching said gift-giving information to said product offers and information according to predetermined criteria;
selecting product offers and information to be transmitted to said display device based upon said gift-giving information;
delivering said selected product offers and information to said system user through said display devices;
storing said matched product offers and information on said display device; and
displaying said delivered matched product offers and information.

9. The method of claim 8, wherein said gift-giving information includes information regarding both the gift receiving recipient and the event for which the gift is to be selected.

10. The method of claim 8, wherein said product offers and information are reserved for later display when said display device is no longer attached to said network.

11. The method of claim 9 wherein said system user is able to initiate a transaction when
said device is not connected to said network.

12. The method of claim 6 wherein said display device is able to store said transaction and automatically connect to said network at a later time based upon pre-selected preferences and system availability.

13. The method of claim 8 wherein said displayed offers can be accessed either from said display device or from a designated website.

14. In an arrangement comprising at least one network linking at least one information system computer, to at least one display device, said display device associated with at least one system user, a method for providing specific product information and offers for sale to said system user, said method comprising the steps of:
gathering product information regarding a variety of product offers and information;
organizing said product offers and information based upon predetermined criteria;
saving said product offers and information in a database;
gathering system user profile information from said system user;
saving said system user profile information;
gathering gift-giving information and profiles regarding future gift recipients from said system user;
saving said gift-giving information;
gathering direct submission information by a third party of identifying information of a system user who has an interest in the offers presented;
organizing said system user profile information, said system user gift recipient profiles and said third party interest direct submission information according to selected criteria based upon the user, and gift recipient's interests and attributes and a specified list of gift giving events for each gift recipient;
saving said system user profile information, said system user gift recipient profiles, and said third party interest identification information;
organizing said system user profile information, and said gift-giving information according to predetermined criteria;
matching said product offers and information to said system user profile information, and to said gift giving information and profiles based upon selected criteria;
selecting product offers and information to be transmitted to said display device based upon matched product results and selected criteria;
delivering program matched product offers and information to said system user through said display devices;
storing said program matched product offers and information on said display device;
receiving offers and information as selected by said shopper and storing said selected offers and information;
displaying on said display device said selected offers and information, and said matched product offers and information upon request by said system user;
storing said displayed offers and information for later on-demand access; and
providing opportunities for interactive purchasing, and communication through said display devices.

15. The method of claim 14 wherein said displayed offers can be accessed from a location other than said display device

16. The method of claim 15 wherein said interactive accepting of purchases, transactions and processes is able to take place when said display device is not connected to said network.

17. The method of claim 16 wherein said device is able to store a transaction, purchase, and process for transmission until a connection between said display and said network becomes available.

18. The method of claim 13 wherein said step of displaying on said display device said selected offers and information further comprises the step of:
initiating specific processes from said display, said specific processes including going back to view a previously displayed product offer and information display, selecting a product information and offer display to be linked to a system user's display, selecting against products and displays that have been matched and presented to said user, but which said user no longer wants to have in their database, accepting identifying product offer and information displays similar to others said user desires receive, allowing said user to identify product offers and informative displays that they would like to purchase at a specific future point in time, and confirming a purchase to take place at a signified point in time.

19. In an arrangement comprising at least one computer network linking at least one information system computer to at least one display device, associated with at least one system user, a method for providing to a system user specific product information, offers for sale, and gift planning based upon information received from said system user, said method comprising the steps of:
gathering information regarding product offers and information from a variety of sources;
organizing said information regarding product offers and information based upon a predetermined criteria;
saving said organized information regarding product offers and information;
gathering system user profile information from said system user by any one of a combination of methods selected from the group consisting of: direct submission from said system users through answers on a profile; monitoring customer interaction with a provided software program; direct submission by a third party system user regarding the party for whom the third party system user intends upon purchasing gifts, and direct submission by a third party of identifying information of a system user who has an interest in the offers presented;
gathering system user gift-recipient profiles from said system user;
gathering third party identification profiles from said system user;
organizing said system user profile information, said system user gift recipient profiles and said third party interest identification profiles according to selected criteria based upon the system user, gift recipient, and identified third party's interests and attributes and a specified list of gift giving events for each gift recipient;
saving said system user profile information, said system user gift recipient profiles, and said third party interest identification information;
matching said product offers and information to said system user profile information, said system user gift recipient profiles, and said third part interest identification profiles according to selected criteria;
organizing said matched product offers and information;
delivering said matched product offers and information to said system users and said third parties via said network;
storing said matched product offers and information;
displaying said delivered matched product offers and information after disconnecting said personal computer from said network;
transmitting transaction requests from said user wherein said transaction requests include making offers to purchase from a seller, placing bids in an electronic auction, placing items for sale in an auction and making offers to sell to a third party, wherein said transaction requests are able to be made when said display device is not connected to said network, said transaction requests being stored within said display device until said display device is connected to said network, whereupon said transaction requests are transmitted to said information system computer.
